(19) United States
(12) Patent Application Publication
(10) Pub. No.: US 2018/0245545 A1
(43) Pub. Date: Aug. 30, 2018

(54) FUEL VOLATILITY SENSOR SYSTEM

(71) Applicant: Eaton Corporation, Cleveland, OH (US)

(72) Inventor: Robert P. Benjey, Dexter, MI (US)

(73) Assignee: Eaton Corporation, Cleveland, OH (US)

(21) Appl. No.: 15/966,755

(22) Filed: Apr. 30, 2018

Related U.S. Application Data
(63) Continuation of application No. PCT/US2016/058792, filed on Oct. 26, 2016.
(60) Provisional application No. 62/248,580, filed on Oct. 30, 2015.
(60) Provisional application No. 62/409,977, filed on Oct. 19, 2016.

(51) Int. Cl. F02M 25/08; F02D 41/00; F02D 19/06

(52) U.S. Cl. CPC F02M 25/0818; F02D 41/004; F02D 19/0628; F02M 25/0872; F02D 2200/0602; F02D 41/0045; F02D 2200/0611; F02D 2200/0606; F02M 25/089

(57) ABSTRACT

A fuel vapor management system for a vehicle includes a vehicle fuel pump assembly and a fuel volatility sensor system having a test chamber and a valve. The test chamber is fluidly coupled to the fuel pump assembly to receive a flow of fuel therefrom, the valve configured to selectively isolate and seal a portion of the fuel flow within the test chamber to determine fuel volatility of the portion of the fuel flow.

### CROSS-REFERENCE TO RELATED APPLICATIONS

This application is a continuation of International Application No. PCT/US2016/058792 filed Oct. 26, 2016, which claims the benefit of U.S. Provisional Application Nos. 62/248,580, filed Oct. 30, 2015 and 62/409,977 filed on Oct. 19, 2016, the contents of which are incorporated herein by reference thereto.

### FIELD

The present disclosure relates generally to fuel vapor management systems for a vehicle and, more particularly, to fuel volatility sensor systems for a vehicle.

### BACKGROUND

Most vehicles include fuel vapor management systems to prevent or reduce emission of volatile fuel vapors into the atmosphere. Typical fuel vapor management systems include a carbon filled canister to absorb unburned fuel vapors, and a conduit system for directing fuel vapors to the carbon filled canister or to an engine intake for combustion therein. Additionally, the fuel vapor management systems may include an on-board diagnostic capability for detecting leaks within the system. Some systems detect fuel vapor pressure during natural vacuum conditions (e.g., during a cool down cycle) as part of the overall process for detecting the presence of leaks. While such known systems function for their intended purposes, it is desirable to provide improved fuel vapor management systems.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In one aspect, a fuel vapor management system for a vehicle having a fuel pump assembly is provided. The fuel vapor management system includes a fuel volatility sensor system having a test chamber and a valve. The test chamber is fluidly coupled to the fuel pump assembly to receive a flow of fuel therefrom, the valve configured to selectively isolate and seal a portion of the fuel flow within the test chamber to determine fuel volatility of the portion of the fuel flow.

In addition to the foregoing, the described fuel vapor management system may include one or more of the following features: a liquid trap configured to separate liquid and vapor fuel, and a venturi fluidly coupled to the liquid trap, wherein the test chamber is fluidly coupled to the venturi; at least one of a pressure sensor and a temperature sensor configured to measure a pressure and/or temperature of the fuel isolated and sealed within the test chamber to determine the Reid vapor pressure (RVP) of the isolated fuel; wherein the venturi is disposed downstream of the test chamber; wherein the venturi is disposed upstream of the test chamber; wherein the valve comprises a first sealing member configured to selectively seal an inlet to the test chamber, and a second sealing member configured to selectively seal an outlet to the test chamber; wherein the valve further comprises a solenoid configured to selectively move the first and second sealing members into respective sealing engagement with the test chamber inlet and the test chamber outlet; wherein the valve comprises a first sealing member configured to selectively seal an inlet to the test chamber, a second sealing member configured to selectively seal an outlet to the test chamber, a third sealing member configured to selectively seal a fuel return conduit, and a fourth sealing member configured to selectively seal the test chamber inlet; a biasing mechanism configured to bias the third sealing member into sealing engagement with the fuel return conduit; wherein the valve is configured to move between a first position where fuel flows through the test chamber, a second position where the test chamber inlet and the fuel return conduit are sealed, and a third position where the test chamber is sealed.

In another aspect, a vehicle is provided. The vehicle includes a fuel tank, a fuel pump assembly, and a fuel vapor management system. The fuel vapor management system includes a liquid trap configured to separate liquid and vapor fuel in the fuel tank, a venturi fluidly coupled to the liquid trap and the fuel pump assembly, and a fuel volatility sensor system having a test chamber and a valve. The test chamber is fluidly coupled to the venturi and the fuel pump assembly, and the test chamber is configured to receive a flow of fuel from the fuel pump assembly. The valve is configured to selectively isolate and seal a portion of the fuel flow within the test chamber to determine fuel volatility of the portion of the fuel flow.

In addition to the foregoing, the described vehicle may include one or more of the following features: wherein the fuel vapor management system further comprises at least one of a pressure sensor and a temperature sensor configured to measure a pressure and/or temperature of the fuel isolated and sealed within the test chamber to determine the Reid vapor pressure (RVP) of the isolated fuel; wherein the venturi is disposed downstream of the test chamber; wherein the venturi is disposed upstream of the test chamber; wherein the valve comprises a first sealing member configured to selectively seal an inlet to the test chamber, and a second sealing member configured to selectively seal an outlet to the test chamber; wherein the valve further comprises a solenoid configured to selectively move the first and second sealing members into respective sealing engagement with the test chamber inlet and the test chamber outlet; wherein the valve comprises a first sealing member configured to selectively seal an inlet to the test chamber, a second sealing member configured to selectively seal an outlet to the test chamber, a third sealing member configured to selectively seal a fuel return conduit fluidly coupled to the venturi, and a fourth sealing member configured to selectively seal the test chamber inlet; a biasing mechanism configured to bias the third sealing member into sealing engagement with the fuel return conduit; and wherein the valve is configured to move between a first position where fuel flows through the test chamber, a second position where the test chamber inlet and the fuel return conduit are sealed, and a third position where the test chamber is sealed.

In yet another aspect, a method of assembling a fuel vapor management system for a vehicle having a fuel pump assembly. The method includes providing a fuel volatility sensor system configured to be disposed within a vehicle fuel tank and receive fuel from the fuel pump assembly, and providing a test chamber within the fuel volatility sensor system configured to be selectively sealed to isolate at least a portion of the fuel supplied by the fuel pump assembly. The fuel volatility sensor system is configured to (a) measure at least one of a pressure and a temperature of the fuel isolated within the test chamber, and (b) determine the Reid vapor pressure (RVP) of the isolated fuel based on the measured pressure and/or temperature.

### BRIEF DESCRIPTION OF THE DRAWINGS

The present disclosure will become more fully understood from the detailed description and the accompanying drawings, wherein:

FIG. 1 is a schematic view of an example fuel vapor management system in accordance with the principles of the present disclosure;

FIG. 2 is a schematic view of another example fuel vapor management system in accordance with the principles of the present disclosure;

FIG. 3 is a perspective view of an example fuel volatility sensor system shown in FIG. 2 in accordance with the principles of the present disclosure;

FIG. 4 is a cross-sectional view of the fuel volatility sensor system shown in FIG. 2 taken along line 4-4 and shown in a first position;

FIG. 5 is a cross-sectional view of the fuel volatility sensor system shown in FIG. 4 in a second position; and

FIG. 6 is a cross-sectional view of the fuel volatility sensor system shown in FIGS. 4 and 5 in a third position.

### DETAILED DESCRIPTION

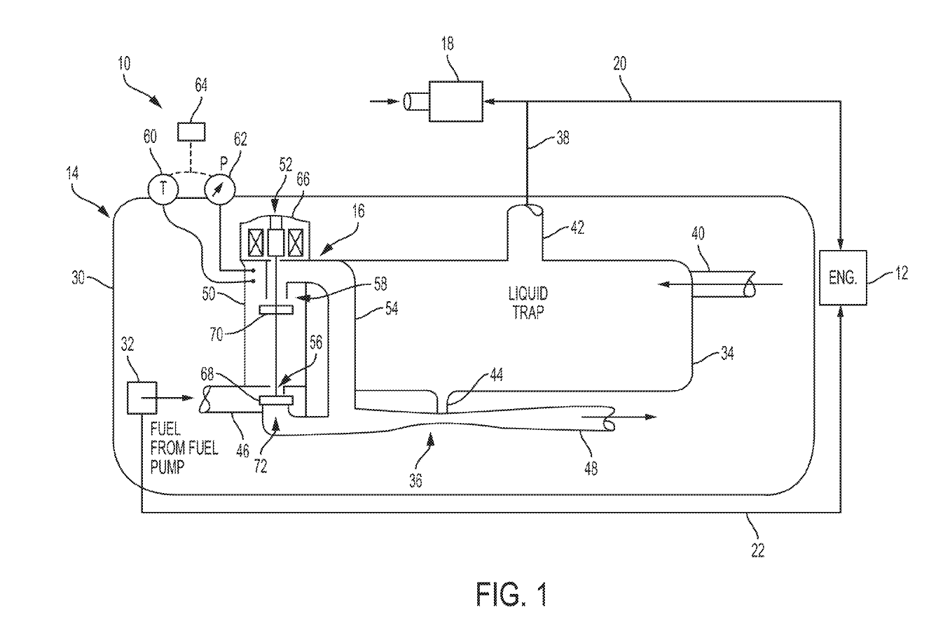

With initial reference to FIG. 1, an example fuel vapor management system 10 is shown. In the illustrated example, the fuel vapor management system 10 is for a vehicle (not shown) such as an automobile having an internal combustion engine 12. However, the fuel vapor management system 10 may be utilized with various other vehicles or systems. The fuel vapor management system 10 can generally include a fuel tank assembly 14, a fuel volatility sensor system 16, a fuel vapor storage canister 18, a purge or vapor fuel line 20, and a liquid fuel line 22.

In the illustrated example, the fuel tank assembly 14 can include a fuel tank 30 having a fuel pump assembly 32, a liquid trap 34, and a venturi pump 36. The fuel pump assembly 32 may include one or more pumps for pressurizing and supplying fuel to fuel injectors (not shown) of the engine 12. Fuel vapors generated in fuel tank 30, for example during refueling, may be directed to the storage canister 18 via a conduit 38. During a purging operation, the fuel vapors stored in the storage canister 18 may subsequently be purged to an intake manifold of engine 12 via the vapor fuel line 20.

The liquid trap 34 can include a vapor inlet conduit 40, a vapor outlet conduit 42, and a liquid drain outlet 44. The liquid trap 34 can be configured to separate liquid and vapor fuel entering the vapor inlet conduit 40, and the separated liquid is subsequently drained back to the fuel tank 30 via the drain outlet 44. The separated vapor is subsequently directed through the vapor outlet conduit 42 to the conduit 38 for removal from the fuel tank 30. The venturi 36 can be configured to drain the liquid trap 34 and can receive fuel from the fuel pump assembly 32 via a fuel conduit 46. The venturi 36 can subsequently return fuel back to the fuel tank 30 via a fuel return conduit 48.

The fuel volatility sensor system 16 can be configured to isolate a fuel sample and monitor the sample to determine fuel volatility. In the illustrated example, the fuel volatility sensor system 16 can generally include a test vessel or chamber 50, a valve 52, and a return conduit 54. As shown in FIG. 1, the fuel volatility sensor system 16 can be coupled to the liquid trap 34 and venturi pump 36 to utilize existing plumbing. However, system 16 may be standalone. The test chamber 50 can include an inlet 56, an outlet 58, a temperature sensor 60, and a pressure sensor 62. The test chamber 50 can have a fixed volume and a fixed vapor space to receive a fuel sample from the fuel tank 30 via the fuel pump assembly 32 and the fuel conduit 46. The chamber inlet 56 can be fluidly coupled to the fuel conduit 46, and the chamber outlet 58 can be fluidly coupled to the return conduit 54 for directing fuel back to the venturi pump 36.

The temperature sensor 60 and/or the pressure sensor 62 can be at least partially disposed within the chamber 50 and can be configured to measure a pressure and/or temperature of a fuel sample contained in the test chamber 50. The sensors 60, 62 can be in signal communication with a controller 64, which can monitor the temperature and/or pressure of the fuel sample in the chamber 50 over time to gauge fuel volatility. The pressure/temperature monitoring, and thus the RVP fuel sample testing, can be accomplished without purposeful manipulation of the pressure and/or temperature of the fuel sample in the test chamber 50. The controller 64 may include one or more look-up tables to determine fuel volatility based on the fixed volume of the chamber 50 and the measured pressure/temperature of the fuel sample in the chamber 50 over a period of time. Fuel volatility measurements are commonly performed in laboratory conditions using Reid Vapor Pressure (RVP) test equipment, while system 16 can utilize the physical properties of the subject test fuel sample capture in chamber 50 along with sensors 60, 62 and predetermined lookup tables to establish the RVP of the sample fuel. Fuel volatility data may then be transmitted to a controller (not shown) such as an engine ECU to aid with leak diagnostics and engine combustion calculations.

As used herein, the term controller refers to an application specific integrated circuit (ASIC), an electronic circuit, a processor (shared, dedicated, or group) and memory that executes one or more software or firmware programs, a combinational logic circuit, and/or other suitable components that provide the described functionality.

In the illustrated example, the valve 52 can include a solenoid 66, a first sealing member 68, and a second sealing member 70. The solenoid 66 can be configured to move the valve 52 between an open position (FIG. 1) and a closed position (not shown). In the open position, the first sealing member 68 can be disposed away from the chamber inlet 56 to seal a venturi inlet 72. As such, fuel flowing from the fuel conduit 46 can enter the test chamber 50 through the unsealed inlet 56. In this position, the second sealing member 70 is disposed away from the chamber outlet 58 such that fuel may flow therethrough into the return conduit 54 and subsequently to the venturi 36.

In the closed position, the first sealing member 68 can seal the chamber inlet 56, and the second sealing member 70 can seal the chamber outlet 58 to thereby isolate and seal a fuel sample within the test chamber 50 for fuel volatility testing and determination. In this position, the venturi inlet 72 can be unsealed such that fuel may flow from the fuel conduit 46 to the venturi 36.

During operation, the valve 52 can be normally maintained in the open position such that fuel flows from the fuel conduit 46, through the test chamber 50, and into the return conduit 54. This can ensure that the test chamber 50 is always full or substantially full of fuel and is ready to check the fuel volatility. When it is desired to check the fuel volatility, the valve 52 can be moved to the closed position to seal the fuel sample inside the test chamber 50. The temperature sensor 60 and pressure sensor 62 can then be utilized to measure the pressure and temperature inside the chamber 50 over time. These measurements can then be used with the known chamber volume to determine the fuel volatility with the look-up table or similar database.

Moreover, natural vacuum conditions that can occur when a fuel system cools can be utilized to calculate leak. Since the RVP curves and test methods can predict the expected pressure rise of a sealed system at higher temperatures, knowing this value for each fuel tank fill-up (and periodically between fill-ups) can offer other opportunities to perform a leak check. The controller 64 can utilize warmer temperature points to measure system leakage by sealing the fuel system and with a known fuel/vapor volume (via a fuel level sensor [not shown]). Then, since the fuel volatility and temperature can be known, the expected change in pressure can be predicted using lookup tables and/or algorithms. If the expected pressure result is not achieved at a predetermined time internal, then a leak exists.

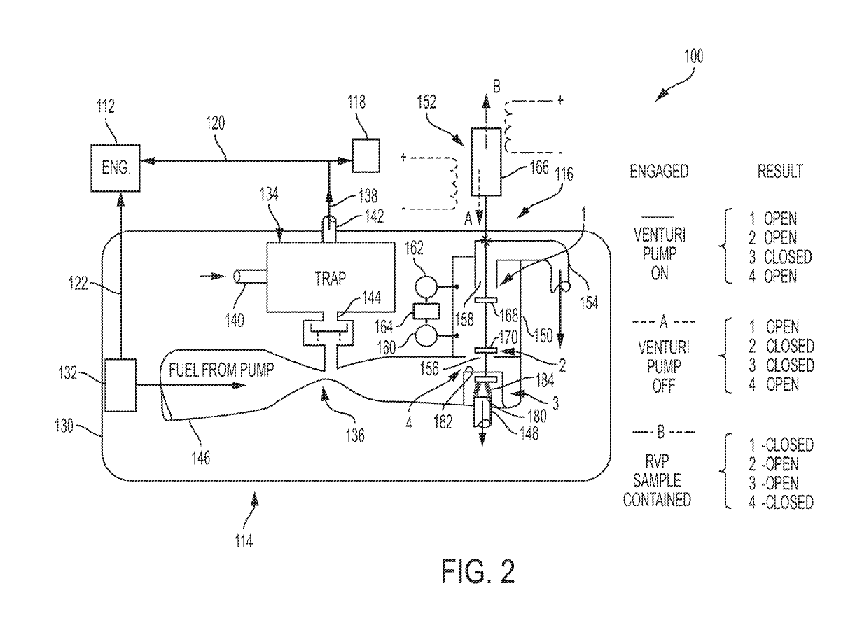

With reference to FIG. 2, an example fuel vapor management system 100 is shown. In the illustrated example, the fuel vapor management system 100 is for a vehicle (not shown) such as an automobile having an internal combustion engine 112. However, the fuel vapor management system 100 may be utilized with various other vehicles or systems. The fuel vapor management system 100 can generally include a fuel tank assembly 114, a fuel volatility sensor system 116, a fuel vapor storage canister 118, a purge or vapor fuel line 120, and a liquid fuel line 122.

In the illustrated example, the fuel tank assembly 114 can include a fuel tank 130 having a fuel pump assembly 132, a liquid trap 134, and a venturi pump 136. The fuel pump assembly 132 may include one or more pumps for pressurizing and supplying fuel to fuel injectors (not shown) of the engine 112. Fuel vapors generated in fuel tank 130, for example during refueling, may be directed to the storage canister 118 via a conduit 138. During a purging operation, the fuel vapors stored in the storage canister 118 may subsequently be purged to an intake manifold of engine 112 via the vapor fuel line 120.

The liquid trap 134 can include a vapor inlet conduit 140, a vapor outlet conduit 142, and a liquid drain outlet 144. The liquid trap 134 can be configured to separate liquid and vapor fuel entering the vapor inlet conduit 140, and the separated liquid is subsequently drained back to the fuel tank 130 via the drain outlet 144. The separated vapor is subsequently directed through the vapor outlet conduit 142 to the conduit 138 for removal from the fuel tank 130. The venturi 136 can be configured to drain the liquid trap 134 and can receive fuel from the fuel pump assembly 132 via a fuel conduit 146. The venturi 136 can subsequently supply fuel back to the fuel tank 130 via a fuel return conduit 148 or to the fuel volatility sensor system 116, as described herein in more detail.

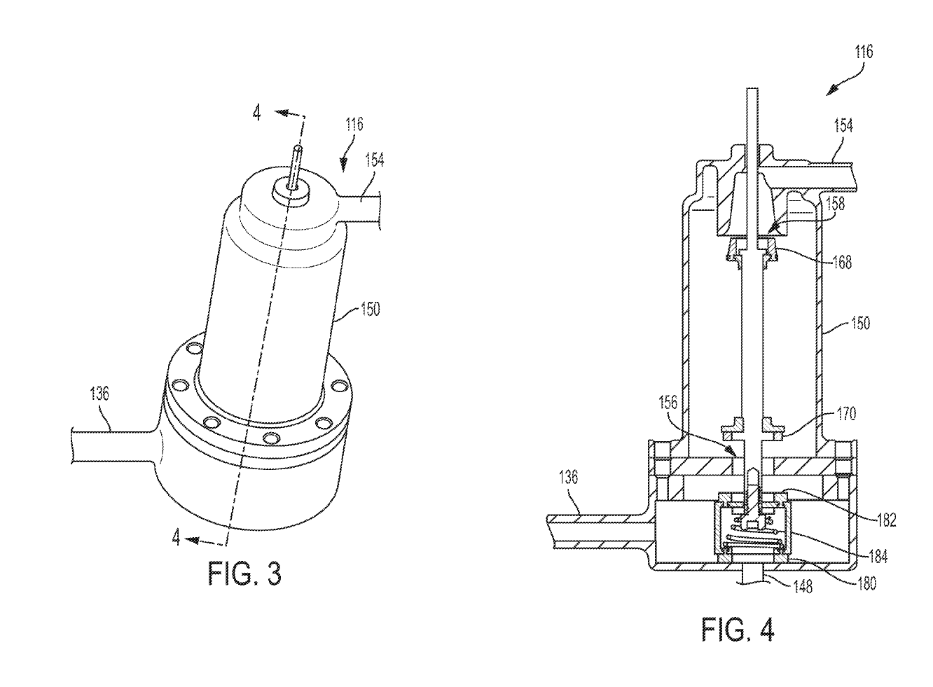

With additional reference to FIGS. 3-6, the fuel volatility sensor system 116 can be configured to isolate a fuel sample and monitor the sample to determine fuel volatility. In the illustrated example, the fuel volatility sensor system 116 can generally include a test vessel or chamber 150, a bi-directional actuator or valve 152, and a return conduit 154. The test chamber 150 can include an inlet 156, an outlet 158, a temperature sensor 160, and a pressure sensor 162. The test chamber 150 can have a fixed volume and a fixed vapor space to receive a fuel sample from the fuel tank 130 via the fuel pump assembly 132 and the fuel conduit 146. The chamber inlet 156 can be fluidly coupled to the venturi 136, and the chamber outlet 158 can be fluidly coupled to the return conduit 154 for directing fuel back to the fuel tank 130.

The temperature sensor 160 and/or the pressure sensor 162 can be at least partially disposed within the chamber 150 and can be configured to measure a pressure and/or temperature of a fuel sample contained in the test chamber 150. The sensors 160, 162 can be in signal communication with a controller 164, which can monitor the temperature and/or pressure of the fuel sample in the chamber 150 over time to gauge volatility. The pressure/temperature monitoring, and thus the RVP fuel sample testing, can be accomplished without purposeful manipulation of the pressure and/or temperature of the fuel sample in the test chamber 150. The controller 164 may include one or more lookup tables and/or algorithms to determine fuel volatility based on the fixed volume of the chamber 150 and the measured pressure/temperature of the fuel sample in the chamber 150.

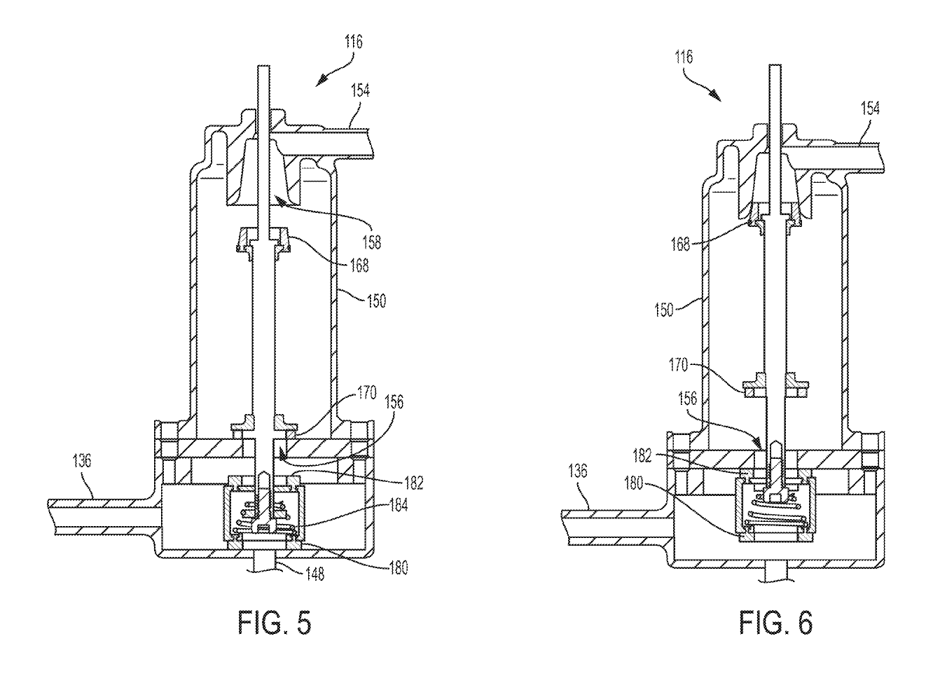

In the illustrated example, the valve 152 can include a solenoid 166, a first sealing member 168, a second sealing member 170, a third sealing member 180, and a fourth sealing member 182. The solenoid 166 can be configured to move the valve 152 between an open first position (FIGS. 2 and 4) where fuel flows from the venturi 136 through the chamber 150, a second position ‘A’ (FIG. 5) where the venturi pump 136 is shut off, and a closed third position ‘B’ (FIG. 6) where a fuel sample is contained in the chamber 150. Valve 152 can optionally include a biasing mechanism 184 configured to bias the third sealing member 180 in a downward direction toward the return conduit 148. In the illustrated example, biasing mechanism 184 is a conical spring. The fourth sealing member 182 can be a box-shaped sealing member configured to seal the chamber inlet 156.

The open first position (FIGS. 2 and 4) can enable a flow of fuel through the chamber 150 to the fuel tank 130. In the open first position, the first sealing member 168 can be disposed away from the chamber outlet 158, the second sealing member 170 can be disposed away from the chamber inlet 156, the third sealing member 180 can seal the return conduit 148, and the fourth sealing member 182 can be disposed away from the chamber inlet 156. As such, fuel flowing from the fuel conduit 146 and venturi 136 can enter the test chamber 150 through the unsealed inlet 156. In this position, the first sealing member 168 is disposed away from the chamber outlet 158 such that fuel may flow therethrough into the return conduit 154 and subsequently to the fuel tank 130.

The second position ‘A’ (FIG. 5) can enable the venturi pump 136 to be shut off, thereby conserving the energy that would normally be required for the fuel pump assembly 132 to supply fuel to the venturi 136. In the second position, the first sealing member 168 can be spaced apart from the chamber outlet 158, the second sealing member can seal the chamber inlet 156, the third sealing member 180 can seal the entrance to the return conduit 148, and the fourth sealing member 182 can be spaced apart from the chamber inlet 156.

The closed third position (FIG. 6) can enable the system 116 to isolate a fuel sample within the test chamber 150 for fuel volatility testing and determination. In the third position ‘B’, the first sealing member 168 can seal the chamber outlet 158, the second sealing member 170 can be spaced apart from the chamber inlet 156, the third sealing member 180 can be spaced apart from the entrance of return conduit 148, and the fourth sealing member 182 can seal the chamber inlet 156. In this position, the return conduit 148 can be unsealed such that fuel may flow from the venturi 136 to the fuel tank 130.

During operation, the valve 152 can be normally maintained in the open first position such that fuel flows from the venturi 136, through the test chamber 150, and into the return conduit 154. This can ensure that the test chamber 150 is always full or substantially full of fuel and is ready to check the fuel volatility. When it is desired to check the fuel volatility, the valve 152 can be moved to the closed third position ‘B’ to seal the fuel sample inside the test chamber 150. The temperature sensor 160 and pressure sensor 162 can then be utilized to measure the pressure and temperature inside the chamber 150 over time. These measurements can then be used with the known chamber volume to determine the fuel volatility with the look-up tables or similar database.

In this example, the outlet from the active drain 144 is directed to the venturi pump 136 and the pump flow can be directed back to the fuel tank 130. By directing this same outlet flow through a selectively sealed chamber 150, a sample of fuel can be accurately captured and RVP measurements made to determine fuel volatility. By utilizing bi-directional actuator 152, the fuel volatility sensor system 116 can shut off the pump flow to the fuel tank 130 when the liquid trap 134 is empty and pumping with fuel pump assembly 132 is unnecessary.

Described herein are systems and methods for determining fuel volatility of fuel in a vehicle. A fuel volatility sensor system includes a test chamber operatively associated with a venturi pump and liquid trap of a fuel tank assembly. The test chamber is selectively sealed by a valve to isolate a fuel sample within the test chamber for on-board fuel volatility testing and determination.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A fuel vapor management system for a vehicle having a fuel pump assembly, the system comprising:
a fuel volatility sensor system having a test chamber and a valve, the test chamber fluidly coupled to the fuel pump assembly to receive a flow of fuel therefrom, the valve configured to selectively isolate and seal a portion of the fuel flow within the test chamber to determine fuel volatility of the portion of the fuel flow.

2. The fuel vapor management system of claim 1, further comprising a liquid trap configured to separate liquid and vapor fuel, and a venturi fluidly coupled to the liquid trap, wherein the test chamber is fluidly coupled to the venturi.

3. The fuel vapor management system of claim 1, further comprising at least one of a pressure sensor and a temperature sensor configured to measure a pressure and/or temperature of the fuel isolated and sealed within the test chamber to determine the Reid vapor pressure (RVP) of the isolated fuel.

4. The fuel vapor management system of claim 2, wherein the venturi is disposed downstream of the test chamber.

5. The fuel vapor management system of claim 2, wherein the venturi is disposed upstream of the test chamber.

6. The fuel vapor management system of claim 1, wherein the valve comprises:
a first sealing member configured to selectively seal an inlet to the test chamber; and
a second sealing member configured to selectively seal an outlet to the test chamber.

7. The fuel vapor management system of claim 6, wherein the valve further comprises a solenoid configured to selectively move the first and second sealing members into respective sealing engagement with the test chamber inlet and the test chamber outlet.

8. The fuel vapor management system of claim 1, wherein the valve comprises:
a first sealing member configured to selectively seal an inlet to the test chamber;
a second sealing member configured to selectively seal an outlet to the test chamber;
a third sealing member configured to selectively seal a fuel return conduit; and
a fourth sealing member configured to selectively seal the test chamber inlet.

9. The fuel vapor management system of claim 8, further comprising a biasing mechanism configured to bias the third sealing member into sealing engagement with the fuel return conduit.

10. The fuel vapor management system of claim 8, wherein the valve is configured to move between a first position where fuel flows through the test chamber, a second position where the test chamber inlet and the fuel return conduit are sealed, and a third position where the test chamber is sealed.

11. A vehicle comprising:
a fuel tank;
a fuel pump assembly; and
a fuel vapor management system comprising:
a liquid trap configured to separate liquid and vapor fuel in the fuel tank;
a venturi fluidly coupled to the liquid trap and the fuel pump assembly; and
a fuel volatility sensor system having a test chamber and a valve, the test chamber fluidly coupled to the venturi and the fuel pump assembly, the test chamber configured to receive a flow of fuel from the fuel pump assembly, the valve configured to selectively isolate and seal a portion of the fuel flow within the test chamber to determine fuel volatility of the portion of the fuel flow.

12. The vehicle of claim 11, wherein the fuel vapor management system further comprises at least one of a pressure sensor and a temperature sensor configured to measure a pressure and/or temperature of the fuel isolated and sealed within the test chamber to determine the Reid vapor pressure (RVP) of the isolated fuel.

13. The vehicle of claim 11, wherein the venturi is disposed downstream of the test chamber.

14. The vehicle of claim 11, wherein the venturi is disposed upstream of the test chamber.

15. The vehicle of claim 11, wherein the valve comprises:
a first sealing member configured to selectively seal an inlet to the test chamber; and
a second sealing member configured to selectively seal an outlet to the test chamber.

16. The vehicle of claim 15, wherein the valve further comprises a solenoid configured to selectively move the first and second sealing members into respective sealing engagement with the test chamber inlet and the test chamber outlet.

17. The vehicle of claim 11, wherein the valve comprises:
a first sealing member configured to selectively seal an inlet to the test chamber;
a second sealing member configured to selectively seal an outlet to the test chamber;
a third sealing member configured to selectively seal a fuel return conduit fluidly coupled to the venturi; and
a fourth sealing member configured to selectively seal the test chamber inlet.

18. The vehicle of claim 17, further comprising a biasing mechanism configured to bias the third sealing member into sealing engagement with the fuel return conduit.

19. The vehicle of claim 17, wherein the valve is configured to move between a first position where fuel flows through the test chamber, a second position where the test chamber inlet and the fuel return conduit are sealed, and a third position where the test chamber is sealed.

20. A method of assembling a fuel vapor management system for a vehicle having a fuel pump assembly, the method comprising:
providing a fuel volatility sensor system configured to be disposed within a vehicle fuel tank and receive fuel from the fuel pump assembly; and
providing a test chamber within the fuel volatility sensor system configured to be selectively sealed to isolate at least a portion of the fuel supplied by the fuel pump assembly,
wherein the fuel volatility sensor system is configured to (a) measure at least one of a pressure and a temperature of the fuel isolated within the test chamber, and (b) determine the Reid vapor pressure (RVP) of the isolated fuel based on the measured pressure and/or temperature.
